(19) United States
(12) Patent Application Publication
(10) Pub. No.: US 2013/0102228 A1
(43) Pub. Date: Apr. 25, 2013

(54) GLASS PLATE, GLASS PLATE POLISHING METHOD, METHOD OF PRODUCING THE SAME, AND APPARATUS FOR PRODUCING THE SAME

(71) Applicant: Asahi Glass Company, Limited, Chiyoda-ku (JP)

(72) Inventors: Masahiro Tsuda, Chiyoda-ku (JP); Kazuhiro Suzuki, Chiyoda-ku (JP); Kentaro Tatsukoshi, Chiyoda-ku (JP); Manabu Nito, Chiyoda-ku (JP)

(73) Assignee: Asahi Glass Company, Limited, Chiyoda-ku (JP)

(21) Appl. No.: 13/715,319

(22) Filed: Dec. 14, 2012

Related U.S. Application Data
(63) Continuation of application No. PCT/JP2011/063836, filed on Jun. 16, 2011.

(30) Foreign Application Priority Data
Jun. 21, 2010 (JP) 2010-140253

(51) Int. Cl. C03B 17/06; B24B 7/24

(52) U.S. Cl. CPC C03B 17/064; B24B 7/241
USPC 451/41; 65/53; 65/195; 501/11

(57) ABSTRACT

A disclosed glass plate is formed by converging flow streams of molten glass, which have a same composition and are caused to flow downward along left and right surfaces respectively of a forming body, in a vicinity of a root of the forming body, wherein neither front nor back surface of the glass plate is polished, wherein a convergent plane between the flow streams deviates to one side from a center plane lying at a center between the front surface of the glass plate and the back surface of the glass plate.

### CROSS-REFERENCE TO RELATED APPLICATIONS

This application is a continuation application filed under 35 U.S.C. 111(a) claiming the benefit under 35 U.S.C. 120 and 365(c) of PCT International Application No. PCT/JP2011/063836 filed on Jun. 16, 2011, which is based upon and claims the benefit of priority of Japanese Patent Application No. 2010-140253, filed on Jun. 21, 2010, the entire contents of which are incorporated herein by reference.

### BACKGROUND OF THE INVENTION

1. Field of the Invention

The present invention relates to a glass plate, a method of polishing the glass plate, a method of producing the glass plate, and an apparatus for producing the glass plate.

2. Description of the Related Art

A fusion method is known as a typical method for producing a glass plate. In the fusion method, molten glass is caused to flow downward as flow streams along left and right surfaces of a forming body, and the flow streams of the molten glass converge (join) together so as to be integrated. Thus, a sheet-like glass (which is also referred to as a “glass ribbon”) is formed. The sheet-like glass is cut so as to have a predetermined size and to be a glass plate as a product.

Meanwhile, heterogeneous material such as heterogeneous glass that is a mixture of glass and foreign material dissolving out of the forming body or the like is likely deposited on a surface of a lower portion of the forming body. Some pieces of the heterogeneous material may flow to the faces of the flow streams that are in contact with the forming body, or to the proximity of the faces. These faces of the flow streams that are in contact with the forming body are to constitute a convergent plane where the left and right flow streams of the molten glass converge. Therefore, the convergent plane or proximity to the convergent plane may contain the heterogeneous material.

In the glass plate formed by the conventional fusion method, the thicknesses of the glass on both sides of the convergent plane are the same. Because of this, the heterogeneous material is rarely exposed to the outside of the glass plate, and the quality of the glass plate rarely suffers from such an adverse effect. Further, the front and back surfaces of the glass plate do not contact the forming body and may be called a pristine surface. Therefore, the front and back surfaces rarely include heterogeneous material or a defect so as not to be in need of polishing for removing the heterogeneous material or the like.

As an exemplary application of the fusion method, International Publication Pamphlet No. WO 2004/094321 and Japanese National Publication of International Patent Application No. 2006-525150 propose a method of manufacturing a glass plate having different compositions in the respective sides of the convergent plane of the flow streams. With this method, the flow streams of molten glass, having the different compositions respectively, flow downward along right and left surfaces respectively of a forming body.

In recent years, weight reduction and thickness reduction have been proceeding in display panels such as a liquid crystal display (LCD) panel, a plasma display panel (PDP), or an organic electroluminescence (EL) panel. Consequently, glass substrates used for display panels are made thinner and thinner. However, if the strength of a glass substrate is lowered due to the thinness of the glass substrate, handling of the glass substrate becomes difficult in the production process of manufacturing display panels.

Therefore, a method is widely employed of thinning at least a part of the glass substrate by polishing the glass substrate such as by etching after laminating the glass substrate having the thickness greater than a final thickness on a counter substrate. An element such as a thin film transistor (TFT) or a color filter (CF) is formed in advance on the surface of the glass substrate that faces the counter substrate. The other surface of the glass substrate opposite to the counter substrate is polished.

In a case where the glass substrate is polished, it is necessary to prepare a glass plate for the glass substrate different from a glass plate formed by the conventional fusion method. The above polishing serves to reduce the thickness of the glass substrate, and includes mechanical polishing and chemical polishing.

### SUMMARY OF THE INVENTION

Accordingly, embodiments of the present invention provide a novel and useful glass plate formed by a fusion method, specifically a novel and useful glass plate suitable for polishing, a method of polishing the glass plate, a method of producing the glass plate, and an apparatus for producing the glass plate solving one or more of the problems discussed above.

According to an aspect of the invention, there is provided a glass plate formed by converging flow streams of molten glass, which have a same composition and are caused to flow downward along left and right surfaces respectively of a forming body, in a vicinity of a root of the forming body, wherein neither front nor back surface of the glass plate is polished, wherein a convergent plane between the flow streams deviates to one side from a center plane lying at a center between the front surface of the glass plate and the back surface of the glass plate.

According to another aspect of the present invention, there is provided a glass plate polishing method of polishing at least the front surface or the back surface of the above glass plate, wherein the polished front or back surface is spaced apart from the convergent plane with a predetermined distance or greater in a thickness direction of the glass plate after the polishing.

In the glass plate polishing method, the above predetermined distance is preferably 0.1 mm.

In the glass plate polishing method, it is preferable that at least a part of the front surface or the back surface, whichever is farther from the convergent plane, undergoes the polishing so that the convergent plane is not removed by the polishing.

In the glass plate polishing method, it is preferable that the glass plate is polished so as to be 0.2 mm to 0.5 mm thick in at least a part of the glass plate.

In the glass plate polishing method, it is preferable that the glass plate is polished so that at least a part of the front surface or the back surface, whichever is closer to the convergent plane, undergoes the polishing so that at least a part of the convergent plane is removed by the polishing.

In the glass plate polishing method, it is preferable that the glass plate is polished so that a removed thickness by the polishing is 0.2 mm or greater.

In the glass plate polishing method, it is preferable that the glass plate is polished so as to be 0.2 mm thick or less in at least a part of the glass plate.

According to another aspect of the present invention, there is provided a method of producing a glass plate including a forming step of forming a sheet-like glass by converging flow streams of molten glass, which have a same composition and are caused to flow downward along left and right surfaces respectively of a forming body, in a vicinity of a root of the forming body, wherein, in the forming step, a convergent plane between the flow streams deviates to one side from a center plane lying at a center between a front surface of the sheet-like glass and a back surface of the sheet-like glass.

In the method of producing the glass plate, it is preferable that the molten glass is caused to overflow a trough, formed in an upper portion of the forming body, onto left and right sides of the forming body, wherein, in the forming step, the forming body is tilted left or right with respect to the sheet-like glass in order to adjust a position of the convergent plane with respect to the center plane.

In the method of producing the glass plate, it is preferable that the molten glass is caused to overflow a trough, formed in an upper portion of the forming body, onto left and right sides of the forming body, wherein, in the forming step, temperature distribution of the molten glass contacting the upper portion of the forming body is adjusted in a left and right direction in order to adjust a position of the convergent plane with respect to the center plane.

In the method of producing the glass plate, it is preferable that the molten glass is caused to overflow a trough, formed in an upper portion of the forming body, onto left and right sides of the forming body, wherein, heights of a left weir of the trough and a right weir of the trough are different from each other.

In the method of producing the glass plate, it is preferable that the molten glass is caused to overflow a trough, formed in an upper portion of the forming body, onto left and right sides of the forming body, wherein a reducing object for reducing a flow volume of a flow stream is positioned higher than a left weir of the trough or a right weir of the trough, the reducing object being positioned on or alongside of one of the left and right surfaces or each of the left and right surfaces of the forming body.

According to another aspect of the present invention, there is provided an apparatus for producing a glass plate including a forming apparatus which forms a sheet-like glass by converging flow streams of molten glass, which have a same composition and are caused to flow downward along left and right surfaces respectively of a forming body, in a vicinity of a root of the forming body, wherein the forming apparatus is configured so that a convergent plane between the flow streams deviates to one side from a center plane lying at a center between a front surface of the sheet-like glass and a back surface of the sheet-like glass.

In the apparatus for producing the glass plate, it is preferable that the molten glass is caused to overflow a trough, formed in an upper portion of the forming body, onto left and right sides of the forming body, wherein the forming apparatus includes a temperature adjusting unit configured to adjust temperature distribution, in a left and right direction, of the flow streams of the molten glass contacting an upper portion of the forming body so that the convergent plane deviates to one side from the center plane.

### BRIEF DESCRIPTION OF THE DRAWINGS

FIG. 1 is a perspective view of a portion of an apparatus for producing a glass plate of a first embodiment;

FIG. 2 is a cross-sectional view of the apparatus for producing the glass plate taken along a line II-II of FIG. 1, wherein molten glass 2 flows downward along left and right surfaces 32 and 33 of a forming body 30;

FIG. 3 is a side view of the glass plate of the first embodiment;

FIG. 4 is a side view (1) of the glass plate illustrated in FIG. 3 after processing the glass plate 10;

FIG. 5 is a side view (2) of the glass plate illustrated in FIG. 3 after processing the glass plate 10;

FIG. 6 is a cross-sectional view of a portion of an apparatus for producing a glass plate of a second embodiment;

FIG. 7 is a cross-sectional view of a portion of an apparatus for producing a glass plate of a third embodiment;

FIG. 8 is a cross-sectional view of a portion of an apparatus for producing a glass plate of a fourth embodiment;

FIG. 9 is a side view of a portion of an apparatus for producing a glass plate, wherein molten glass 2 flows downward along left and right surfaces of a forming body 30; and

FIG. 10 illustrates a variation of the apparatus for producing the glass plate illustrated in FIG. 9.

### DETAILED DESCRIPTION OF THE PREFERRED EMBODIMENTS

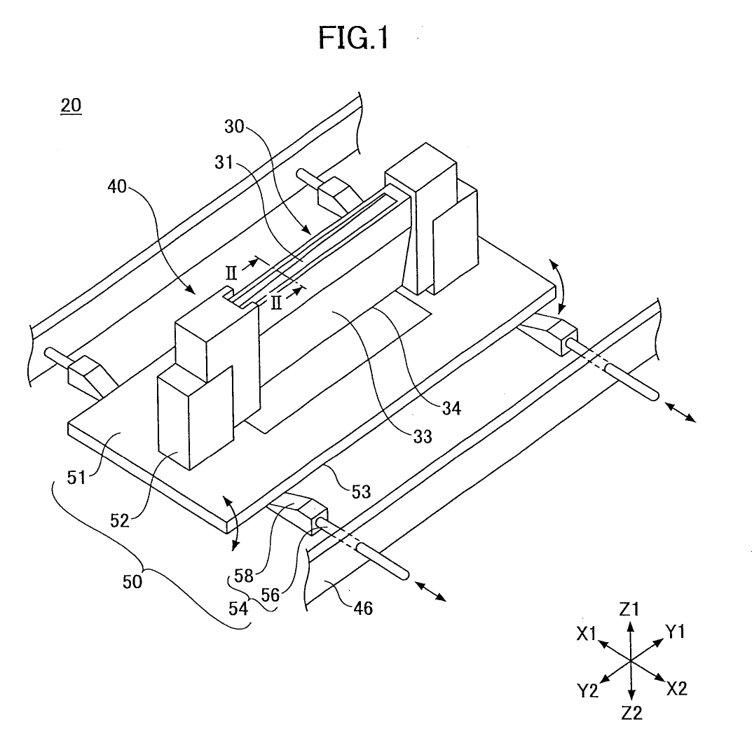

A description is given below, with reference to the FIG. 1 through FIG. 10 of embodiments of the present invention. Where the same reference symbols are attached to the same parts, repeated descriptions of the parts are omitted.

### First Embodiment

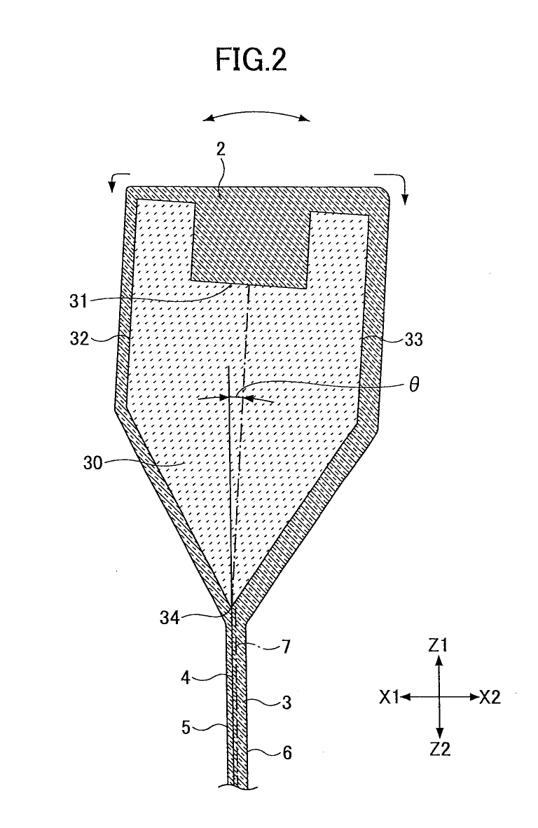

FIG. 1 is a perspective view of a portion of an apparatus for producing a glass plate of the first embodiment. FIG. 2 is a cross-sectional view of the apparatus for producing the glass plate taken along a line II-II of FIG. 1, wherein flow streams of molten glass 2 flow downward along left and right surfaces 32 and 33 of a forming body 30, respectively. Referring to FIGS. 1 and 2, arrows X1 and X2 represent a thickness direction of the glass plate, arrows Y1 and Y2 represent a width direction of the glass plate, and arrows Z1 and Z2 represent a longitudinal direction of the glass plate.

The apparatus for producing the glass plate of the first embodiment includes a forming apparatus 20 for forming the molten glass 2 into a sheet-like glass 3. The forming apparatus 20 includes a forming body 30 and a forming chamber 40 inside which the forming body 30 is located.

The forming body 30 is made of a refractory material such as alumina or zirconia. The forming body 30 has a wedge-like shape that tapers downward. A trough 31 is formed in an upper portion of the forming body 30. The molten glass 2 is supplied into the trough 31 via a molten glass delivery pipe (not shown). The molten glass 2 overflows the trough 31, formed in the upper portion of the forming body 30, onto the left side along the arrow X1 and the right side along the arrow X2, and the flow streams flow downward along the left and right surfaces 32 and 33 of the forming body 30, respectively.

The flow streams flowing downward along the left and right surfaces 32 and 33 respectively of the forming body 30 converge in the vicinity of a root of the forming body 30 and are integrated so as to be a sheet-like glass 3 (the sheet-like glass is also referred to as a glass ribbon.

The sheet-like glass 3 is drawn downward in a vertical direction along the arrow Z2 from the forming chamber 40. The sheet-like glass 3 is cut into a predetermined size so as to be a glass plate as a product.

The forming apparatus 20 includes a tilting mechanism 50. The tilting mechanism 50 is provided to cause a convergent plane 4 of the flow streams of the molten glass to deviate to one side from a center plane 7 lying at a center between a front surface 5 and a back surface 6 (toward the front surface 5 or the back surface 6). In other words, the thicknesses of the glass sheets on the respective sides of the convergent plane 4 are made different from each other. The tilting mechanism 50 causes the forming body 30 to tilt left or right with respect to the sheet-like glass 3.

For example, the tilting mechanism 50 includes a base 51, a connector 52 and supporters 54. The base 51 supports the forming body 30 with the connector 52. The supporters 54 support the base 51 to raise or lower the left or right side of the base 51 so that the base 51 can be tilted with respect to the vertical direction.

Referring to FIG. 1, each of the supporters 54 may include a rod 56 penetrating a sidewall 46 of the forming chamber 40 and a tilting member 58 contacting an outer edge 53 of the base 51. The rod 56 and the tilting member 58 may be integrally formed. The number of the supporters 54 may be two for each of the left and right outer edges 53 of the base 51. The rods 56 are supported by the sidewall 46 so as to be moved in the left and right direction along the arrows X1 and X2, which are a longitudinal direction or an axial direction of the rods 56. Each of the tilting members 58 has a surface tilted with respect to the axial direction of the corresponding rod 56.

In the tilting mechanism 50, the rods 56 may be moved by hand or by a suitable driving device. When the two rods 56 on one side of the base 51 are moved left or right along the arrows X1-X2 with respect to the sidewall 46, the tilting members 58 cause the one side of the base 51 to move in an up or down direction along the arrow Z1 or Z2. As a result, the forming body 30 is tilted left or right with respect to the sheet-like glass 3.

When the forming body 30 is tilted left or right with respect to the sheet-like glass 3, the molten glass 2 overflowing the trough 31, formed in the upper portion of the forming body 30, onto left and right sides of the forming body 30 has different overflow volumes in the left and right due to the influence of gravity. Thus, the flow volumes of flow streams of the molten glass 2 flowing downward along the left and right surfaces 32 and 33 respectively of the forming body 30 differ from each other. As a result, the thickness of the sheet-like glass 3 between the front surface 5 and the convergent plane 4 and the thickness of the sheet-like glass 3 between the back surface 6 and the convergent plane 4 differ from each other so that the position of the convergent plane deviates from the center plane 7.

Therefore, within the first embodiment, it is possible to cause the convergent plane 4 to deviate to one side from the center plane 7 in parallel by tilting the center axis of the forming body 30 right or left with respect to the longitudinal direction of the sheet-like glass 3 using the tilting mechanism 50.

Further, by adjusting a tilt angle θ between a longitudinal direction of the sheet-like glass 3 and a center line of the forming body 30, it is possible to adjust the position of the convergent plane 4 with respect to the center plane 7. It is preferable to adjust the tilt angle θ in a range of 0.02° to 5°. It is more preferable to adjust the tilt angle in a range of 0.04° to 2°, further more preferably in a range of 0.1° to 1°. If the tilt angle is smaller than 0.02°, the length of the deviation in the convergent plane 4 from the center plane 7 may not be sufficient. Further, when the tilt angle θ is greater than 5°, the glass plate may not be stably formed.

Next, a method of producing the glass plate using the above producing apparatus is described.

The composition of the glass plate is appropriately selected depending on an intended end-usage or the like of the glass plate. For example, in a case where the intended end-usage of the glass plate is a plasma panel, soda-lime glass having a high temperature of strain point and a high thermal expansion coefficient may be used. Further, if an intended end-usage of the glass plate is a liquid crystal panel, alkali-free glass substantially containing no alkali metal is used, because an alkali metal adversely affects the quality of the liquid crystal panel.

For example, the alkali-free glass, as represented by mass percentage based on the following oxides, contains SiO₂: 50 to 66%; Al₂O₃: 10.5 to 22%; B₂O₃: 0 to 12%; MgO: 0 to 8%; CaO: 0 to 14.5%; SrO: 0 to 24%; and BaO: 0 to 13.5% where MgO+CaO+SrO+BaO: 9 to 29.5 mass %.

The molten glass 2 is produced by putting plural types of raw materials, corresponding to the composition of the glass plate, into a melter and melting the plural types of raw materials. The molten glass 2 is delivered into the trough 31, formed in the upper portion of the forming body 30, through a molten glass delivery pipe. Before the molten glass 2 is delivered into the trough 31, it is preferable to remove bubbles from the molten glass 2.

The method of producing the glass plate of the first embodiment includes a forming step of forming the molten glass 2 to be the sheet-like glass 3. Specifically, the molten glass 2 having the same composition is caused to overflow the trough 31 formed in the upper portion of the forming body 30, flow downward along the left and right surfaces 32, 33 of the forming body 30, and converge in the vicinity of the root 34 of the forming body 30 so that the sheet-like glass 3 is formed.

The sheet-like glass 3 is drawn downward in the vertical direction along the arrow Z2 from the forming chamber 40. Thereafter, the sheet-like glass 3 is cut so as to have a predetermined size. Thus, the cut sheet-like glass 3 is a glass plate as a product.

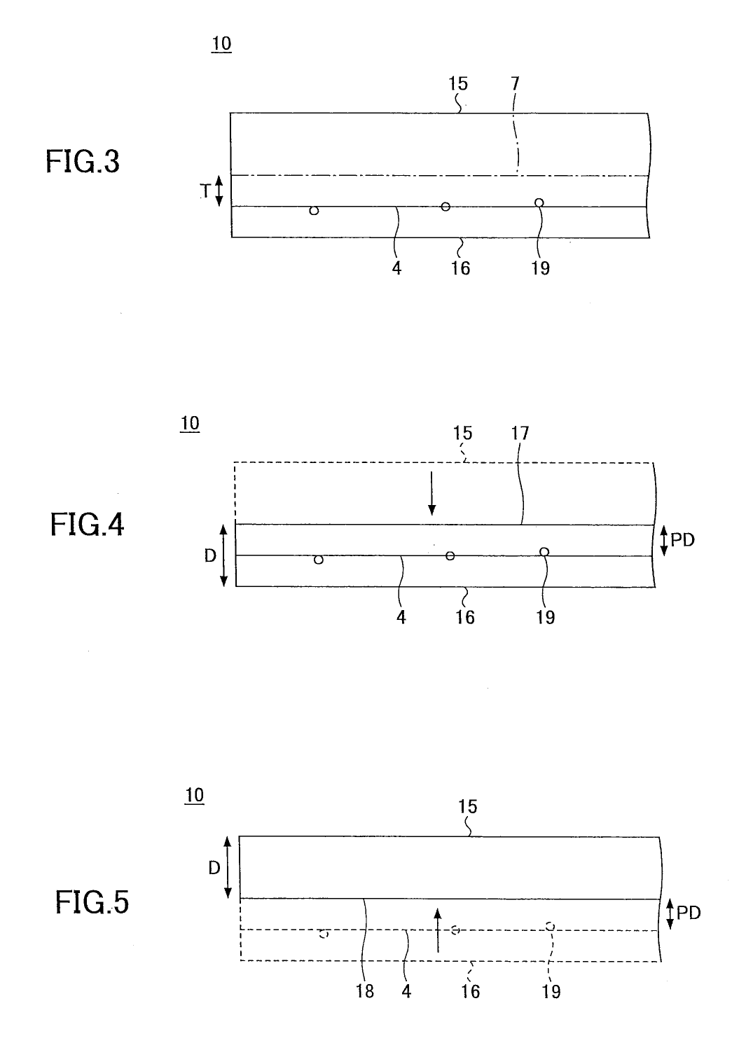

Within the first embodiment, it is possible to cause the convergent plane 4 to deviate to one side from the center plane 7 in parallel by tilting the center axis of the forming body 30 right or left with respect to the longitudinal direction of the sheet-like glass 3 using the tilting mechanism 50. Thus, the glass plate 10 (see FIG. 3) is obtained as described later.

Further, within the first embodiment, it is possible to adjust the position of the convergent plane 4 with respect to the center plane 7 as described by tilting the center axis of the forming body 30 right or left with respect to the longitudinal direction of the sheet-like glass 3 using the tilting mechanism 50. Thus, it is possible to easily deal with a passive change in glass-forming conditions such as time degradation of the forming body 30, or with an intentional change in glass-forming conditions required by users of the glass plate 10 such as a change in the usage process of the glass plate 10.

Next, referring to FIG. 3, the glass plate 10 obtained by the above production method is described.

Since the glass plate 10 is basically the same as the sheet-like glass 3, glass composition is the same between the two sides of the convergent plane 4 formed with the flow streams of the molten glass 2. The thickness of the glass plate 10 between a front surface 15 and the convergent plane 4 differs from the thickness of the glass plate 10 between a back surface 16 and the convergent plane 4. The convergent plane 4 deviates to one side from the center plane 7 lying at a center between the front surface 15 and the back surface 16 in parallel (toward the front surface 15 or the back surface 16). The front and the back surfaces 15 and 16 of the glass plate 10 are not polished after the forming process.

The convergent plane 4 can be detected by visual inspection of a cut plane of the glass plate 10 with an optical microscope.

The convergent plane 4 or a portion of the glass plate 10 in the vicinity of the convergent plane 4 may contain some pieces of heterogeneous material 19 separated from the lower surface of the forming body 30. Without polishing, the heterogeneous material 19 is scarcely exposed on the front or back surface 15 or 16 of the glass plate 10. Therefore, the quality of the glass plate 10 may not be adversely affected. Especially, when a piece of the heterogeneous material has a size of less than 0.1 mm, the adverse effect scarcely occurs. Thus, the glass plate 10 containing some pieces of the heterogeneous material 19 can be accepted as a product.

As described, in the glass plate 10 of the first embodiment, the convergent plane 4 deviates to one side from the center plane 7, and the thickness of the glass plate 10 between the front surface 15 and the convergent plane 4 and the thickness of the glass plate 10 between the back surface 16 and the convergent plane 4 are different from each other. Therefore, the glass plate 10 is suitable for polishing as described later. Even upon being polished, the glass plate 10 is not likely to have the heterogeneous material 19 exposed to the outside.

A deviation T (see FIG. 3) of the convergent plane 4 from the center plane 7 may be determined depending on the intended end-usage of the glass plate 10 or the like. The deviation T may be 0.1 mm or greater.

In the example illustrated in FIG. 3, the back surface 16 is closer to the convergent plane 4 than the front surface 15. The deviation T may be set so that a distance between the back surface 16 and the convergent plane 4 becomes 0.1 mm or greater. This is because, if the deviation is smaller than 0.1 mm, the heterogeneous material 19 may be undesirably exposed to the outside before polishing the glass plate 10.

Referring to FIGS. 4 and 5, a polishing method of polishing the glass plate 10 is described. In the polishing method, at least a part of the front or back surface 15 or 16 of the glass plate 10 is polished.

The polishing method uses, for example, chemical polishing, mechanical polishing or the like. Here, the chemical polishing includes etching. Hereinafter, a case of using etching is described. However, another chemical process or other mechanical polishing may be similarly applicable.

The etching may be wet etching or dry etching. In the wet etching, the glass plate 10 is immersed in an etching liquid to thin the glass plate 10. The etching liquid is an acid aqueous solution or the like.

Before the etching process, a part of the glass plate 10 may be covered with an etching resistant material. A portion of the glass plate 10 covered with the etching resistant material is not etched. As an etching resistant material, a high-polymer material such as Teflon (“Teflon” is a registered trademark) may be used. The etching resistant material is removed by, for example, an organic solvent after etching the glass plate 10.

This etching process may be performed during, although not specifically limited to, the manufacturing process of a display panel such as a liquid crystal display (LCD) panel, a plasma display panel (PDP) or an organic electroluminescence (EL) panel. Further, the etching process may be performed during the manufacturing process of an illumination panel.

In the case of being performed during the manufacturing process of display panels, the etching process may be performed, as a non-limiting example, after laminating the glass plate 10 and a counter substrate. For example, in the case of being performed during the manufacturing process of liquid crystal panels, the etching process may be performed after laminating the glass plate 10 and the counter substrate with an interposing spacer therebetween. In this case, an element of a thin film transistor (TFT), a color filter (CF) or the like may be formed in advance on the surface of the glass plate 10 that faces the counter substrate, and the other surface of the glass plate 10 opposite to the counter substrate undergoes the etching process.

Within the first embodiment, after the etching process, an etched surface 17 (see FIG. 4) and an etched surface 18 (see FIG. 5) are apart from the convergent plane 4 in the thickness direction of the glass plate 10 with predetermined distances PD. Therefore, after the etching process, heterogeneous material 19 contained in the convergent plane 4 or a portion in the vicinity of the convergent plane 4 is scarcely exposed to the outside. Therefore, the quality of the display panel may not be adversely affected.

The above predetermined distances PD may be determined based on the intended end-usage or the like of the glass plate 10. This is because a permissible size of a piece of the heterogeneous material 19 depends on the intended end-usage or the like of the glass plate 10. A piece of heterogeneous material 19 smaller than 0.1 mm may be permissible in most intended end-usages so far as the heterogeneous material is not exposed to the outside. Meanwhile, when the predetermined distance PD is 0.1 mm, it is possible to prevent the small piece of heterogeneous material 19 from being exposed to the outside. The above predetermined distance PD is preferably 0.05 mm or greater, more preferably 0.1 mm or greater. The above predetermined distance PD may be 0.2 mm or greater, 0.3 mm or greater, or 0.4 mm or greater.

In the example illustrated in FIG. 4, in order to avoid removing the convergent plane 4 through etching, etching is performed with respect to at least a part of the front surface 15 that is farther from the convergent plane 4 than the back surface 16 of the glass plate 10. Therefore, the heterogeneous material 19 contained on the convergent plane 4 or a portion in the vicinity of the convergent plane 4 is scarcely exposed to the outside during the etching process. Thus, etching anisotropy caused by the heterogeneous material scarcely occurs. Therefore, after the etching process, the surface undergoing etching is likely flat.

This method is suitable for a case where the thickness D in at least a part of the glass plate 10 is 0.2 to 0.5 mm. When the thickness D is less than 0.2 mm, it is difficult to prevent the heterogeneous material 19 from being exposed to the outside while maintaining the convergent plane 4. When the thickness D is 0.5 mm or greater, the effect of thinning the plate D is not sufficient.

In the example illustrated in FIG. 5, in order to remove at least a part of the convergent plane 4 through etching, etching is performed with respect to at least a part of the back surface 16 that is closer to the convergent plane 4 than the front surface 16 of the glass plate 10. In this case, a portion of the glass plate 10 inclusive of vicinity on both sides of the convergent plane 4 is removed. Therefore, after the etching process, the heterogeneous material 19 is scarcely exposed to the outside. Therefore, the quality of the display panel or the like may not be adversely affected. Further, the removal of a thinner one of the glass layers that are situated on the respective sides of the convergent plane 4 serves to relatively quickly remove the heterogeneous material 19.

Within the first embodiment, after the etching process, an etched surface 18 (see FIG. 5) is preferably apart from the convergent plane 4 in the thickness direction of the glass plate 10 with 0.1 mm or greater. Because the heterogeneous material 19 is removed before finishing the etching process, it is possible to reduce the influence of the etching anisotropy caused by the heterogeneous material 19. Further, in order to remove the convergent plane 4 by the etching process and to further remove the heterogeneous material, it is preferable to remove 0.2 mm or more of glass in the thickness direction of the glass plate 10 from the surface that is closer to the convergent plane 4 than the other surface.

This method is suitable for a case where the thickness D in at least a part of the glass plate 10 after the etching process is less than 0.2 mm. When the thickness D is less than 0.2 mm, it is difficult to prevent the heterogeneous material 19 from being exposed to the outside while maintaining the convergent plane 4 as illustrated in FIG. 4.

### Second Embodiment

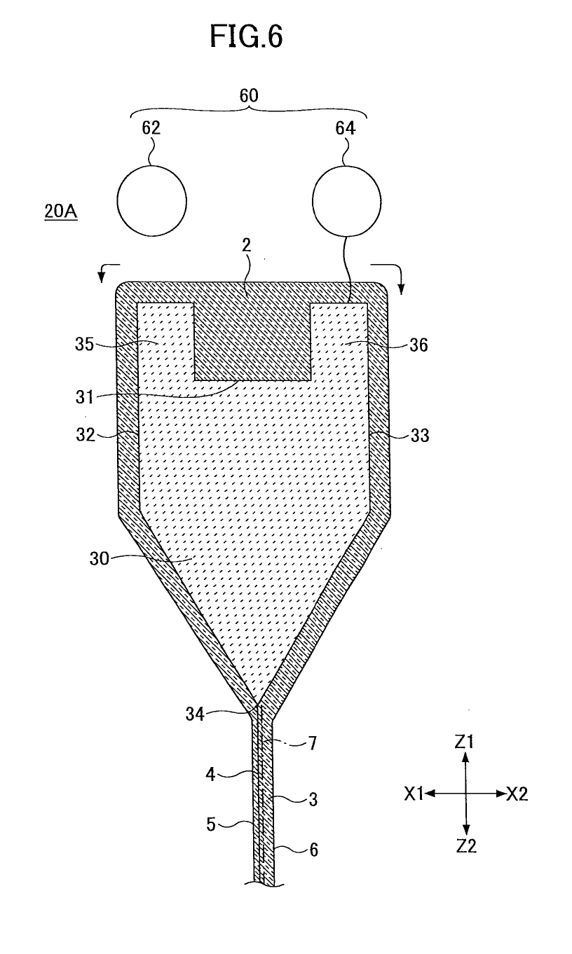

FIG. 6 is a cross-sectional view of a portion of an apparatus for producing a glass plate of the second embodiment. The cross-sectional view of FIG. 6 corresponds to FIG. 2.

The apparatus for producing the glass plate of the second embodiment is different in the structure of a forming apparatus 20A. The forming apparatus 20A includes a temperature adjusting unit 60 so that a convergent plane 4 of flow streams of molten glass 2 deviates to one side from a center plane 7 lying at a center between a front surface 5 and a back surface 6 of the sheet-like glass 3. The temperature adjusting unit 60 is provided to adjust a temperature distribution, in a left and right direction along arrows X1 and X2, of the molten glass 2 which is in contact with the upper portion of the forming body 30.

For example, the temperature adjusting unit 60 may be composed of heating elements 62 and 64 and so on as illustrated in FIG. 6. The heating elements 62 and 64 are positioned above the forming body 30. The heating elements 62 and 64 are arranged left and right. These heating elements 62 and 64 may be divided in the width direction of the molten glass 2 along arrows Y1 and Y2. In this case, a temperature distribution of the molten glass 2 in the width direction may be controlled to be even.

In this temperature adjusting unit 60, it is possible to independently control calorific power of the heating elements 62 and 64 thereby adjusting the temperature distribution of the molten glass 2, which contacts the upper portion of the forming body 30, in a left and right direction. When the temperature distribution changes, the viscosity property of the molten glass 2 overflowing onto the left side of the forming body 30 is not the same as the viscosity property of the molten glass 2 overflowing onto the right side of the forming body 30. Therefore, the volume of an overflow of the molten glass 2 having a relatively low viscosity property is more than the volume of an overflow of the molten glass 2 having a relatively high viscosity property. Thus, the volumes of overflows of the molten glass 2 flowing onto the left and right sides, respectively, differ from each other. Therefore, the volumes of flow streams of the molten glass 2 flowing downward along the left and right surfaces 32 and 33, respectively, of the forming body 30 differ from each other. As a result, the thickness of a sheet-like glass 3 between the front surface 5 and the convergent plane 4 and the thickness of the sheet-like glass 3 between the back surface 6 and the convergent plane 4 differ from each other so that the position of the convergent plane 4 deviates from the center plane 7.

Therefore, it is possible to cause the convergent plane 4 to deviate to one side from the center plane 7 in parallel by adjusting the temperature distribution of the molten glass contacting the upper portion of the forming body 30, in a left and right direction, using the temperature adjusting unit 60. Thus, a glass plate 10 as illustrated in FIG. 3 is obtained in a manner similar to the first embodiment.

Therefore, it is possible to adjust the position of the convergent plane 4 with respect to the center plane 7 by adjusting the temperature distribution, in the left and right direction, of the molten glass contacting the upper portion of the forming body 30 using the temperature adjusting unit 60. With this, it is possible to easily deal with a change or a modification of the glass forming conditions.

Within the second embodiment, only one of the heating elements 62 and 64 may be used as a temperature adjusting unit 60, instead of using both of the heating elements 62 and 64. A cooling element may be used instead of the heating elements 62 and 64. A flow path for flowing a cooling medium is provided inside the cooling element. When the cooling element is made of a material having high heat conductivity such as a metallic material, the flow path may not have to be provided.

Further, in the second embodiment, the heating elements 62 and 64 are provided above the forming body 30. Alternatively, the heating element may be provided inside the forming body 30. For example, the heating element 62 may be provided inside a left weir 35 of a trough 31, and the heating element 64 may be provided inside a right weir 36 of the trough 31.

### Third Embodiment

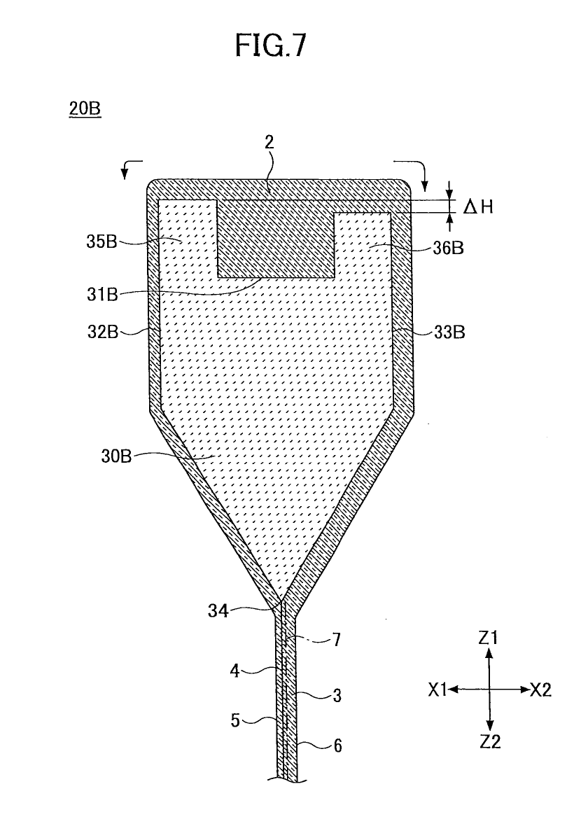

FIG. 7 is a cross-sectional view of a portion of an apparatus for producing a glass plate of the third embodiment. The cross-sectional view of FIG. 7 corresponds to FIG. 2.

The apparatus for producing the glass plate of the third embodiment is different in the structure of a forming apparatus 20B. The forming apparatus 20B includes a forming body 30B so that a convergent plane 4 of flow streams of molten glass 2 deviates to one side from a center plane 7 lying at a center between a front surface 5 and a back surface 6 of the sheet-like glass 3. In the forming body 30B, a left weir 35B of a trough 31B and a right weir 36B of the trough 31B have different heights. One of the left weir 35B of the trough 31B and the right weir 36B of the trough 31B protrudes higher by ΔH than the other one of the left weir 35B of the trough 31B and the right weir 36B of the trough 31B. It is preferable that ΔH is 0.1 to 10 mm, more preferably 0.2 to 5 mm, and further preferably 0.4 to 2 mm. If ΔH is smaller than 0.1 mm, the shift length of the convergent plane 4 from the center plane 7 may not be sufficient. Further, when ΔH is greater than 10 mm, the glass plate may not be stably formed.

Because the molten glass 2 is influenced by the force of gravity, the volumes of overflows of the molten glass 2 flowing onto the left and right sides, respectively, from the trough 31B formed in an upper portion of the forming body 30B differ from each other. As a result, the volumes of flow streams of the molten glass 2 flowing downward along the left and right surfaces 32B and 33B, respectively, of the forming body 30B are different from each other. Therefore, the convergent plane 4 deviates to one side from the center plane 7. Thus, a glass plate 10 as illustrated in FIG. 3 is obtained in a manner similar to the first embodiment.

### Fourth Embodiment

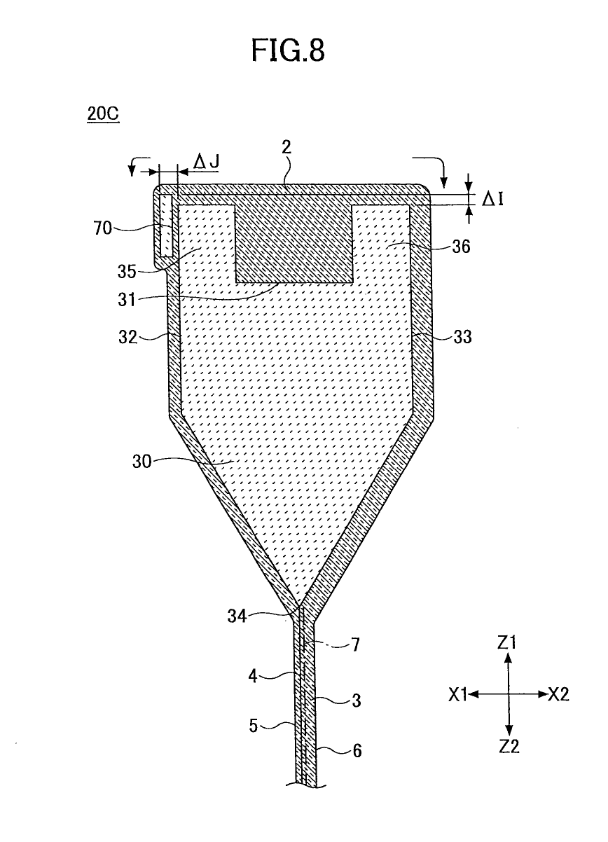

FIG. 8 is a cross-sectional view of a portion of an apparatus for producing a glass plate of the fourth embodiment. The cross-sectional view of FIG. 8 corresponds to FIG. 2.

The apparatus for producing the glass plate of the fourth embodiment is different in the structure of a forming apparatus 20C. The forming apparatus 20C includes a reducing object 70 so that a convergent plane 4 of flow streams of molten glass 2 deviates to one side from a center plane 7 lying at a center between a front surface 5 and a back surface 6 of the sheet-like glass 3. The reducing object 70 is provided on an upper portion of a left or right weir 35 or 36 of the trough 31 provided on an upper portion of a forming body 30. The reducing object 70 reduces the flow volume of the flow streams of the molten glass 2 which flows downward along a left surface 32 or a right surface 33 of the forming body 30.

As illustrated in FIG. 8, the reducing object 70 may be provided on or alongside of the upper portion of the left weir 35 of the trough 31 so as to be positioned higher than the right weir 36 of the trough 31. The material of the reducing object 70 is not specifically limited. The material of the reducing object 70 may be the same as the material of the forming body 30, for example.

If the reducing object 70 is structured to be positioned higher than the right weir 36 of the trough 31, the molten glass is influenced by the force of gravity. Therefore, the volumes of overflows of the molten glass 2 flowing onto the left and right sides, respectively, of the forming apparatus 20C from a trough 31, formed in the upper portion of the forming body 30, differ from each other. As a result, the volumes of flow streams of the molten glass 2 flowing downward along the left and right surfaces 32 and 33, respectively, of the forming body 30 are different from each other. Therefore, the convergent plane 4 deviates to one side from the center plane 7 in parallel. Thus, a glass plate 10 as illustrated in FIG. 3 is obtained in a manner similar to the first embodiment.

Further, the reducing object 70 may be movable so that a projecting amount ΔI, by which the top of the reducing object 70 is positioned higher than the top of the right weir 36 of the trough 31, and/or a distance ΔJ between the left surface of the reducing object 70 and the left weir 35 of the trough 31 are variable. If the projecting amount ΔI and/or the distance ΔJ is changed, the volumes of overflows of the molten glass flowing from the trough 31 formed in the upper portion of the forming body 30 onto the left and right sides, respectively, also change. This is because when the projecting amount ΔI is changed, the influence of the force of gravity also changes. If the distance ΔJ is changed, the distance the molten glass 2 travels is also changed to thereby change an influence of the frictional resistance. As a result, the thickness of the sheet-like glass 3 between the front surface 5 and the convergent plane 4 and the thickness of the sheet-like glass 3 between the back surface 6 and the convergent plane 4 differ from each other to thereby change the position of the convergent plane 4 with respect to the center plane 7.

Therefore, by adjusting the projecting amount ΔI and/or the distance ΔJ using the reducing object 70, it is possible to adjust the position of the convergent plane 4 with respect to the center plane 7. With this, it is possible to easily deal with a change or a modification of the glass forming conditions, in a manner similar to the first embodiment.

Further, the reducing object 70 may be exchangeable so as to be replaced by a part having a different shape in order to change the projecting amount ΔI and/or the distance ΔJ.

Within the fourth embodiment, the reducing object 70 is provided on or alongside of the upper portion of the left weir 35 of the trough 31 so as to be positioned higher than the right weir 36 of the trough 31. However, the present invention is not limited thereto. For example, the reducing object 70 may be provided on or alongside of the upper portion of the right weir 36 of the trough 31 so as to be positioned higher than the left weir 35 of the trough 31.

### Fifth Embodiment

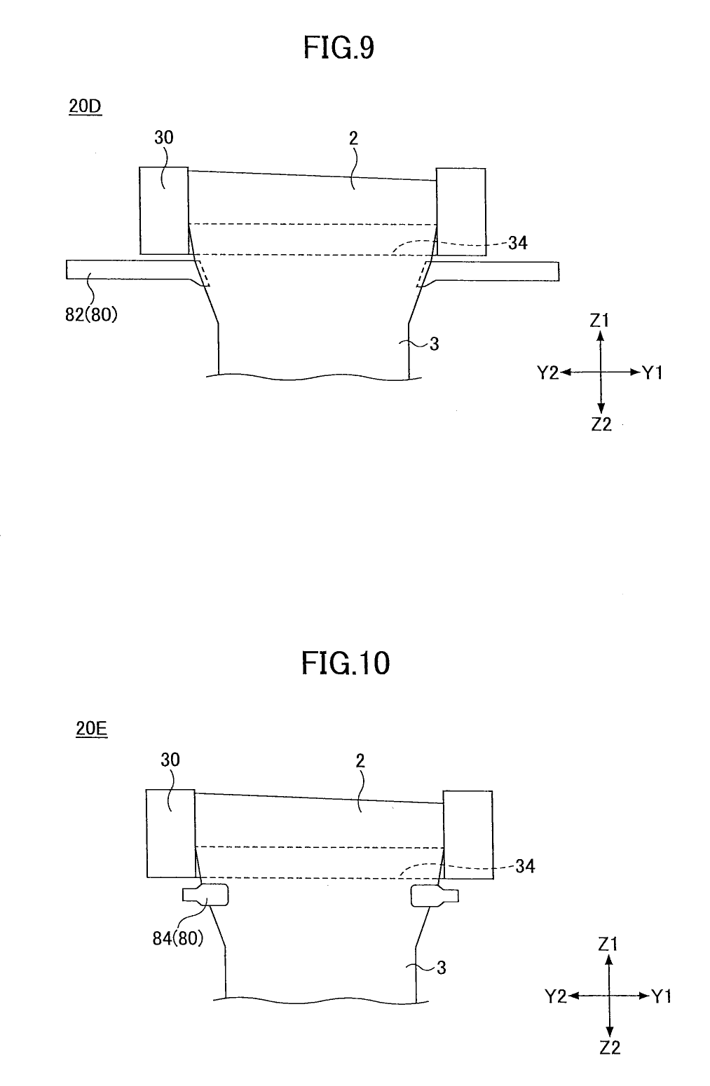

FIG. 9 is a side view of a portion of an apparatus for producing a glass plate, wherein molten glass 2 is caused to flow downward along left and right surfaces of a forming body 30. FIG. 10 illustrates a modified example of the apparatus for producing the glass plate illustrated in FIG. 9.

The apparatus for producing the glass plate of the fifth embodiment is different in the structure of forming apparatuses 20D and 20E. Each of the forming apparatuses 20D and 20E includes a pair of guide members 80 for controlling sheet-like glass 3 below forming bodies 30. The pair of the guide members 80 prevent the width of the sheet-like glass 3 from narrowing and the thickness of the sheet-like glass 3 from being ununiform.

The guide members 80 are, for example, edge guide members 82 illustrated in FIG. 9, paired cooling rollers 84 illustrated in FIG. 10, or the like. The edge guide members 82 are shaped like, for example, a plate. Leading end portions of the edge guide members 82 are in contact with the side edges of the sheet-like glass 3. The paired cooling rollers 84 are comprised of a pair of rollers. The paired cooling rollers 84 send the sheet-like glass 3 downward while pinching the side edges of the sheet-like glass 3.

The positions of the guide members 80 are set so that a front surface 5 and a back surface 6 of the sheet-like glass 3 (see FIG. 2, for example) in the middle of the width direction of the sheet-like glass 3 become flat, and front and back surfaces 15 and 16 of a glass plate 10 to be produced become flat. The positions of the guide members 80 may be adjusted in response to a positional change of the convergent plane 4 with respect to the center plane 7. For example, the position of each guide member 80 may be moved in the left and right directions along arrows X1 and X2 in conformity with adjustment of the tilt angle θ illustrated in FIG. 2.

Further, when the temperature distribution of the molten glass 2 contacting the upper portion of the forming body 30 is adjusted in the left and right direction, using a temperature adjusting unit 60, the position of the guide member 80 can be moved left and right along the arrows X1 and X2. Further, the position of the guide member 80 can be moved left and right along the arrows X1 and X2 in response to the adjustments of the projecting amount ΔI and the distance ΔJ illustrated in FIG. 7. With this, it is possible to produce the glass plate 10 having excellent flatness (according to Japanese Industrial Standards, “JIS B0021:1998”). The flatness of the glass plate 10 to be produced is preferably 1 mm or smaller, more preferably 0.5 mm or smaller, and further more preferably 0.3 mm or smaller.

Although the present invention has been described with respect to first to fifth embodiments, the present invention is not to be limited by the above embodiments, and it is possible to add various modifications and alternative constructions to the above embodiments without departing from the spirit and scope of the present invention.

For example, as a structure in which the convergent plane 4 of flow streams of the molten glass 2 deviates to one side from the center plane 7 lying at a center between the front and back surfaces 5 and 6 of the sheet-like glass 3, combinations of at least two of the tilting mechanism 50, the temperature adjusting unit 60, the forming body 30B, and the reducing object 70 may be used. The number of the combinations is not limited.

The present invention is described above in detail with reference to specific embodiments and practical examples, however, it may be apparent to those skilled in the art that various variations and modifications may be made without departing from the spirit and scope of the present invention.

What is claimed is:

1. A glass plate formed by converging flow streams of molten glass, which have a same composition and are caused to flow downward along left and right surfaces respectively of a forming body, in a vicinity of a root of the forming body,
wherein neither front nor back surfaces of the glass plate is polished,
wherein a convergent plane between the flow streams deviates to one side from a center plane lying at a center between the front surface of the glass plate and the back surface of the glass plate.

2. A glass plate polishing method of polishing at least the front surface or the back surface of the glass plate according to claim 1,
wherein the polished front or back surface is spaced apart from the convergent plane with a predetermined distance or greater in a thickness direction of the glass plate after the polishing.

3. The glass plate polishing method according to claim 2,
wherein the predetermined distance is 0.1 mm.

4. The glass plate polishing method according to claim 2,
wherein at least a part of the front surface or the back surface, whichever is farther from the convergent plane, undergoes the polishing so that the convergent plane is not removed by the polishing.

5. The glass plate polishing method according to claim 4,
wherein the glass plate is polished so as to be 0.2 mm to 0.5 mm thick in at least a part of the glass plate.

6. The glass plate polishing method according to claim 2,
wherein the glass plate is polished so that at least a part of the front surface or the back surface, whichever is closer to the convergent plane, undergoes the polishing so that at least a part of the convergent plane is removed by the polishing.

7. The glass plate polishing method according to claim 6,
wherein the glass plate is polished so that a removed thickness by the polishing is 0.2 mm or greater.

8. The glass plate polishing method according to claim 6,
wherein the glass plate is polished so as to be 0.2 mm thick or less in at least a part of the glass plate.

9. A method of producing a glass plate comprising:
a forming step of forming a sheet-like glass by converging flow streams of molten glass, which have a same composition and are caused to flow downward along left and right surfaces respectively of a forming body, in a vicinity of a root of the forming body,
wherein, in the forming step, a convergent plane between the flow streams deviates to one side from a center plane lying at a center between a front surface of the sheet-like glass and a back surface of the sheet-like glass.

10. The method of producing the glass plate according to claim 9,
wherein the molten glass is caused to overflow a trough, formed in an upper portion of the forming body, onto left and right sides of the forming body,
wherein, in the forming step, the forming body is tilted left or right with respect to the sheet-like glass in order to adjust a position of the convergent plane with respect to the center plane.

11. The method of producing the glass plate according to claim 9,
wherein the molten glass is caused to overflow a trough, formed in an upper portion of the forming body, onto left and right sides of the forming body,
wherein, in the forming step, temperature distribution of the molten glass contacting the upper portion of the forming body is adjusted in a left and right direction in order to adjust a position of the convergent plane with respect to the center plane.

12. The method of producing the glass plate according to claim 9,
wherein the molten glass is caused to overflow a trough, formed in an upper portion of the forming body, onto left and right sides of the forming body,
wherein, heights of a left weir of the trough and of a right weir of the trough, are different from each other.

13. The method of producing the glass plate according to claim 9,
wherein the molten glass is caused to overflow a trough, formed in an upper portion of the forming body, onto left and right sides of the forming body,
wherein a reducing object for reducing a flow volume of a flow stream is positioned higher than a left weir of the trough or a right weir of the trough, the reducing object being positioned on or alongside of one of the left and right surfaces or each of the left and right surfaces of the forming body.

14. An apparatus for producing a glass plate comprising:
a forming apparatus which forms a sheet-like glass by converging flow streams of molten glass, which have a same composition and are caused to flow downward along left and right surfaces respectively of a forming body, in a vicinity of a root of the forming body,
wherein the forming apparatus is configured so that a convergent plane between the flow streams deviates to one side from a center plane lying at a center between a front surface of the sheet-like glass and a back surface of the sheet-like glass.

15. The apparatus for producing the glass plate according to claim 14,
wherein the molten glass is caused to overflow a trough, formed in an upper portion of the forming body, onto left and right sides of the forming body,
wherein the forming apparatus includes a temperature adjusting unit configured to adjust temperature distribution, in a left and right direction, of the molten glass contacting an upper portion of the forming body so that the convergent plane deviates to one side from the center plane.
